(19) United States
(12) Patent Application Publication
(10) Pub. No.: US 2012/0304956 A1
(43) Pub. Date: Dec. 6, 2012

(54) PISTON WITH WELD HARDENED RING GROOVE AND METHOD OF CONSTRUCTION THEREOF

(76) Inventors: Kai Wang, Ann Arbor, MI (US); Eduardo H. Matsuo, Ann Arbor, MI (US)

(21) Appl. No.: 13/153,552

(22) Filed: Jun. 6, 2011

(51) Int. Cl. F02F 3/00; B23P 15/10

(52) U.S. Cl. 123/193.6; 29/888.04

(57) ABSTRACT

A piston and method of construction is provided. The piston includes a top part and a bottom part fixed to one another. The bottom part includes a pair of pin bosses providing a pair of laterally spaced pin bores aligned with one another along a pin bore axis. A friction weld joint bonds the top part to the bottom part. The top part and/or the lower part has an annular ring groove configured for receipt of a piston ring, wherein the ring groove has a thermally hardened surface formed by a hardened region of the heat affected zone.

### BACKGROUND OF THE INVENTION

1. Technical Field

This invention relates generally to internal combustion engines, and more particularly to pistons and their method of construction.

2. Related Art

Engine manufacturers are encountering increasing demands to improve engine efficiencies and performance, including, but not limited to, improving fuel economy, improving fuel combustion, reducing oil consumption, increasing the exhaust temperature for subsequent use of the heat within the vehicle, increasing compression loads within the cylinder bores, decreasing weight and making engines more compact. Accordingly, it is desirable to increase the temperature and compression loads within the combustion chamber of the engine. However, by increasing the temperature and compression loads within the combustion chamber, the wear and physical demands on the piston are increased, thereby reducing its potential useful life. A particular area of concern is with the wear within the ring grooves of the piston. In order to address this area of concern, it is known to use secondary processes to harden the material of the piston within the ring grooves, thereby increasing the wear resistance of the flanks of the piston material forming the ring grooves. Although the secondary processes are useful in enhancing the resistance to wear within the ring grooves, the secondary process add cost to the manufacturing process of the piston.

A piston constructed in accordance with this invention overcomes at least the aforementioned disadvantages of known piston constructions, as will become apparent to those skill in the art upon reading the disclosure and viewing the drawings herein.

### SUMMARY OF THE INVENTION

A piston for an internal combustion engine constructed in accordance with one aspect of the invention is economical in manufacture and exhibits a long and useful life. The piston includes a top part having an uppermost surface with annular outer upper joining surface depending from the uppermost surface and a bottom part friction welded to the top part. The bottom part includes a pair of pin bosses providing a pair of laterally spaced pin bores aligned with one another along a pin bore axis and an upwardly extending annular outer lower joining surface. A friction weld joint bonds the upper joining surface of the top part to the lower joining surface of the bottom part. The top part and/or the lower part has an annular ring groove configured for receipt of a piston ring, wherein the ring groove has a thermally hardened surface within a heat affected zone of the friction weld joint.

In accordance with another aspect of the invention, the top part of the piston includes an uppermost compression ring groove that is at least partially located within the heat affected zone of the weld joint.

In accordance with yet another aspect of the invention, the uppermost compression ring groove in the top part is the sole annular ring groove in the top part.

In accordance with yet another aspect of the invention, the friction weld joint is formed within about 4 mm of an axially lowermost surface of the uppermost compression ring groove in the top part.

In accordance with yet another aspect of the invention, a method of constructing a piston for an internal combustion engine is provided. The method includes providing a top part having an uppermost surface with annular outer upper joining surface depending from the uppermost surface, and providing a bottom part having a pair of pin bosses providing a pair of laterally spaced pin bores aligned with one another along a pin bore axis and having an upwardly extending annular outer lower joining surface. Further, forming a friction weld joint bonding the upper joining surface to the lower joining surface and forming a hardened region within a heat affected zone of the friction weld joint. Then, forming an annular piston ring groove in at least a portion of the hardened region.

In accordance with another aspect of the invention, the method further includes forming at least one of the annular ring grooves as an uppermost compression ring groove in the top part.

In accordance with another aspect of the invention, the method further includes forming the uppermost compression ring groove as the sole annular ring groove in the top part.

In accordance with another aspect of the invention, the method further includes forming a piston ring groove in the lower part that remains outside the heat affected zone of the friction weld joint.

A piston and method of construction thereof provides a compression ring groove having a hardened surface to enhance the running performance of the piston and thus, the running performance of the engine therewith. Further, the useful life of the piston and the engine is increased. In addition, the manufacturing process used to construct the piston, including forming the compression ring groove within at least a portion of the heat affected zone is economical, in that a minimal number of processes are used for the construction and hardening of the compression ring groove, and thus, the total cost of producing the piston is minimized.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a partially cross-sectioned perspective view of a piston constructed in accordance with one aspect of the invention; and

FIG. 2 is an enlarged cross-sectional side view of the general area encircled by circle 2 of FIG. 1.

### DETAILED DESCRIPTION OF PRESENTLY PREFERRED EMBODIMENTS

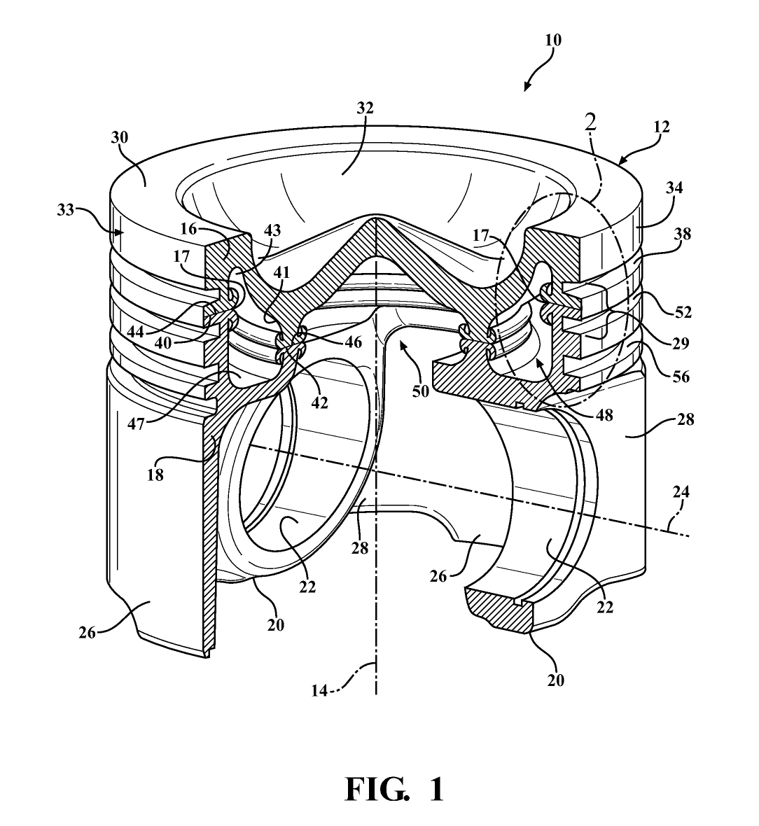

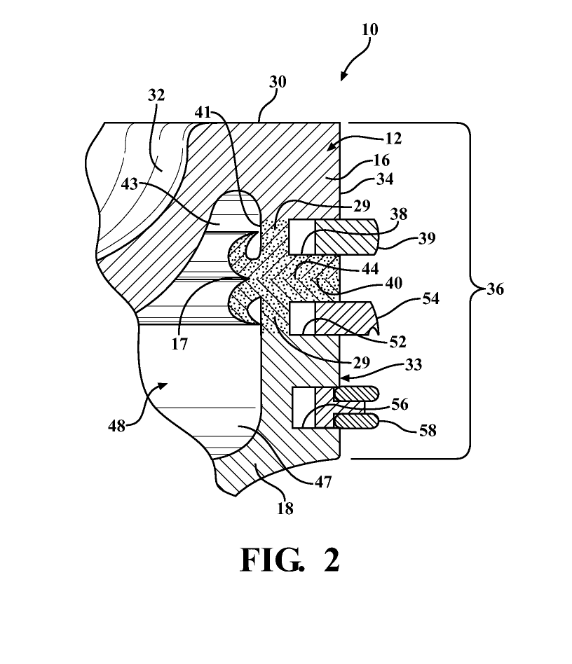

Referring in more detail to the drawings, FIGS. 1 and 2 illustrate a piston assembly, referred to hereafter simply as piston 10, constructed according to one presently preferred embodiment of the invention for reciprocating movement in a cylinder bore or chamber (not shown) of an internal combustion engine, such as a new generation heavy duty diesel engine, for example. The piston 10 has a body 12, either cast or forged, or formed by any other process of manufacture, extending along a central longitudinal axis 14 along which the piston 10 reciprocates in the cylinder bore. The body 12 has two parts, including a top part, also referred to as upper crown 16, and a bottom part, also referred to as lower crown 18, joined to one another via a friction welding process along a friction weld joint 17. Reference to “top”, “bottom”, “upper” and “lower” herein are relative to the piston being oriented along the vertical longitudinal central piston axis 14 along which the piston 10 reciprocates in use. This is for convenience and is not to be limiting since it is possible that the piston may be installed and operate at an angle or other than purely vertical. The lower crown 18 has a pair of pin bosses 20 depending from the upper crown 16 to provide laterally spaced pin bores 22 aligned along a pin bore axis 24 that extends generally transverse to the central longitudinal axis 14. The pin bosses 20 are joined to diametrically spaced skirt portions 26 via strut portions 28. The friction weld joint 17, aside from joining the upper crown 16 to the lower crown 18, produces a heat affected zone 29 that forms a hardened region containing at least one piston ring groove, thereby resulting in a ring groove that is resistant to wear from the corresponding piston ring received therein. Accordingly, additional processes are not necessary to harden the ring groove within the hardened region of the heat affected zone 29, thereby minimizing the process steps and the costs associated with the manufacture of the piston 10.

The upper crown 16 of the piston 10 is represented here as having an upper combustion surface 30 with a combustion bowl 32 recessed therein to provide a desired gas flow with the cylinder bore. An outer cylindrical wall 33, including an upper land 34 immediately adjacent the combustion surface 30 and a portion of a ring belt 36, extends downwardly from the upper surface 30 to an outer upper joining surface, also referred to as outer free end 40. The portion of the ring belt 36 extending about the upper crown 16 includes at least one annular ring groove, shown here as a single uppermost compression ring groove 38 for floating receipt of a compression piston ring 39 (FIG. 2). The compression ring groove 38 is formed within or substantially within a hardened region of the heat affected zone 29 of the friction weld joint 17. Accordingly, upon forming the weld joint 17 and then forming the compression ring groove 38, at least a portion of the ring groove 38 is pre-hardened about its exposed outer surface and throughout the heat affected zone 29. Accordingly, the compression ring groove 38 is automatically provided with an increased hardness relative to the remaining portion of the piston outside the heat affected zone 29, thereby increasing the resistance of the ring groove 38 to wear from the compression ring 39 without need of secondary hardening processes. To ensure the compression ring groove 38 is sufficiently hardened, the axially lowermost surface of the compression ring groove 38 is formed within about 4 mm of the friction weld joint 17, and thus, within about 4 mm from the outer free end 40. The upper crown 16 is shown, by way of example and without limitation, as having an annular inner rib 41 that depends from an under surface of the combustion bowl 32 to an inner upper joining surface, also referred to as inner free end 42. The outer free end 40 and the inner free end 42 delimit an upper outer gallery portion 43.

The lower crown 18 is constructed separately from the upper crown 16, such as in a forging process, by way of example and without limitation, and then friction welded to the upper crown 16 via at least an upstanding annular outer lower joining surface, also referred to as outer rib free end 44. The lower crown 18 is also shown, by way of example and without limitation, as having an upstanding annular inner lower joining surface, also referred to as inner rib free end 46, wherein the outer and inner joining surfaces 44, 46 delimit a lower outer gallery portion 47. Upon friction welding the upper and lower crowns 16, 18 to one another across their respective outer free ends 40, 44 and inner free ends 42, 46, a substantially closed outer oil gallery 48 is bounded by the upper and lower outer gallery portions 43, 47 of the upper and lower crowns 16, 18, while an open inner gallery 50 is formed upwardly of the pin bores 22 beneath a central portion of the combustion bowl 32. It should be recognized that the piston 10, constructed in accordance with the invention, could have upper and lower crown portions formed otherwise, having different configurations of oil galleries, for example. Further, the lower crown 18 is shown, by way of example, as forming a lower portion of the ring belt 36 via inclusion of a wiper ring groove 52 adjacent the outer rib free end 44 for receipt of a wiper ring 54. The wiper ring groove 52 is formed within or substantially within the hardened region of the heat affected zone 29 of the friction weld joint 17, and thus, the wiper ring groove 52 is hardened about its exposed outer surface and throughout the heat affected zone 29. Accordingly, the wiper ring groove 52 is automatically provided with an increased resistance to wear from the wiper ring 54 as a result of the friction welding process. To ensure the wiper ring groove 52 is sufficiently hardened, the axially uppermost surface of the wiper ring groove 52 is formed within about 4 mm of the friction weld joint 17, and thus, within about 4 mm from the outer free end 44. In addition to the wiper ring groove 52, the lower crown 18 is also shown having a lowermost oil ring groove 56 for receipt of an oil ring 58 beneath the wiper ring 54. The oil ring groove 56 is shown as being formed outside the hardened region of the heat affected zone 29, and thus, the oil ring groove 56 remains unhardened relative to the compression ring groove 38 and the wiper ring groove 52.

In accordance with another aspect of the invention, a method of constructing a piston 10 for an internal combustion engine is provided. The method includes providing a top part 16 having an uppermost surface 30 with annular outer upper joining surface 40 depending from the uppermost surface 30. Further, providing a bottom part 18 having a pair of pin bosses 20 providing a pair of laterally spaced pin bores 22 aligned with one another along a pin bore axis 24 and having an upwardly extending annular outer lower joining surface 44. Then, forming a friction weld joint 17 bonding the upper joining surface 40 to the lower joining surface 44 and simultaneously hardening a region within a heat affected zone 29 of the weld joint 17. Further yet, forming at least one or a plurality of annular piston ring grooves 38, 52 in at least one of the top part 16 and the bottom part 18, such that the ring grooves 38, 52 are at least partially formed within the hardened region formed by the heat affected zone 29.

Obviously, many modifications and variations of the present invention are possible in light of the above teachings. It is, therefore, to be understood that within the scope of the appended claims, the invention may be practiced otherwise than as specifically described.

What is claimed is:

1. A piston for an internal combustion engine, comprising:
a top part having an uppermost surface with annular outer upper joining surface depending from said uppermost surface;
a bottom part having a pair of pin bosses providing a pair of laterally spaced pin bores aligned with one another along a pin bore axis and having an upwardly extending annular outer lower joining surface;
a friction weld joint bonding said upper joining surface to said lower joining surface; and
wherein at least one of said top part and said lower part has an annular ring groove configured for receipt of a piston ring, said ring groove having a thermally hardened surface within a heat affected zone of said friction weld joint.

2. The piston of claim 1 wherein at least one of said annular ring groove is an uppermost compression ring groove in said top part.

3. The piston of claim 3 wherein said uppermost compression ring groove is the sole annular ring groove in said top part.

4. The piston of claim 1 wherein said top part and said lower part each have an annular ring groove having a thermally hardened surface within a heat affected zone of said friction weld joint.

5. The piston of claim 4 wherein said friction weld joint is between said ring grooves of said top part and said lower part.

6. The piston of claim 5 wherein said weld joint is spaced axially from annular ring grooves of said top part and said lower part.

7. The piston of claim 5 wherein said ring groove in said top part is an uppermost compression ring groove.

8. The piston of claim 7 wherein said ring groove in said lower part is a wiper ring groove.

9. The piston of claim 4 wherein said lower part has an annular ring groove outside the heat affected zone of said friction weld joint.

10. The piston of claim 1 wherein said top part has an inner upper joining surface depending from said uppermost surface radially inwardly from said annular outer upper joining surface and said bottom part has an upwardly extending annular inner lower joining surface friction welded to said inner upper joining surface.

11. A method of constructing a piston, comprising:
providing a top part having an uppermost surface with annular outer upper joining surface depending from the uppermost surface;
providing a bottom part having a pair of pin bosses providing a pair of laterally spaced pin bores aligned with one another along a pin bore axis and having an upwardly extending annular outer lower joining surface;
forming a friction weld joint bonding the upper joining surface to the lower joining surface and forming a hardened region within a heat affected zone of the friction weld joint; and
forming at least one annular piston ring groove in at least a portion of the hardened region of the heat affected zone.

12. The method of claim 11 further including forming at least one of the annular ring grooves as an uppermost compression ring groove in the top part.

13. The method of claim 12 further including forming the uppermost compression ring groove as the sole annular ring groove in the top part.

14. The method of claim 11 further including forming piston ring grooves in the top part and the bottom part with the piston ring grooves being formed within the hardened region of the heat affected zone.

15. The method of claim 14 further including forming the ring groove in the top part as an uppermost compression ring groove.

16. The method of claim 15 further including forming the piston ring grooves on opposite sides of the heat affected zone.

17. The method of claim 15 further including forming the ring grooves in axially spaced relation from the weld joint.

18. The method of claim 14 further including forming a piston ring groove in the lower part outside the hardened region of the heat affected zone.

19. The method of claim 11 further including providing the top part with an inner upper joining surface depending from the uppermost surface radially inwardly from the annular outer upper joining surface and providing the bottom part with an upwardly extending annular inner lower joining surface and friction welding the inner lower joining surface to the inner upper joining surface.
